(19) United States
(12) Patent Application Publication
(10) Pub. No.: US 2024/0151986 A1
(43) Pub. Date: May 9, 2024

(54) FRAME FOR EYEGLASSES WITH COLOR GRADATION

(71) Applicant: LUXOTTICA S.R.L., Agordo (IT)

(72) Inventor: Nicolò CRESTALE, Albettone (IT)

(21) Appl. No.: 18/504,572

(22) Filed: Nov. 8, 2023

(30) Foreign Application Priority Data
Nov. 9, 2022 (IT) 102022000023094

(51) Int. Cl. G02C 5/00; B32B 7/03; B32B 23/04; B32B 37/12; B32B 37/22

(52) U.S. Cl. CPC G02C 5/008; B32B 7/03; B32B 23/04; B32B 37/12; B32B 37/22; B32B 2250/03; B32B 2250/24; B32B 2307/402; G02C 2200/14

(57) ABSTRACT

A frame for eyeglasses with color gradation, including at least one first acetate sheet having a color gradation at least on part of the first acetate sheet and a transparency along at least one second part, and at least one second acetate sheet having a color gradation on at least one part of the second acetate sheet, the first and second acetate sheets being coupled together by superimposition.

### CROSS-REFERENCE TO RELATED APPLICATIONS

This application claims the benefit of Italian patent application 102022000023094, filed on 9 Nov. 2022, the disclosure of which is incorporated herein by reference in its entirety.

### TECHNICAL FIELD

The present disclosure relates to a frame for eyeglasses with color gradation.

More specifically, the present disclosure relates to an eyeglasses frame that is provided with an aesthetic effect with color gradations preferably on the front part of the frame. In an alternative embodiment the color gradation is visible both on the front and on the rear of the frame, by virtue of the transparency of the material which makes the color gradation visible on the opposite side as well.

### BACKGROUND

As is known, eyeglasses frames have always been the focus of research into styling and appearance, as well as research into materials.

Eyeglasses frames can have many and varied forms, so as to suit various different types of face. In addition to the more classic closed-circle shapes, research into styling also explores newer, “goggle”-type shapes.

Eyeglasses frames can be made using various different types of materials. The best-known and most commonly-used is cellulose acetate. This material, widely used in eyewear, is a modified natural polymer.

Making cellulose acetate begins with the selection of cotton tufts. From this, the purest part of the cellulose is extracted and is subsequently treated and converted to cellulose acetate powder. The powder obtained is then mixed with substances such as plasticizers in order to confer characteristics of workability when hot, flexibility, and toughness; additives to stabilize the material against light and heat, and also coloring agents (dyes and pigments).

To make the frame, different types of ecologically sustainable material can be used, for example bioacetate, wherein the plasticizers are of plant origin, or other materials obtained by recycling (e.g. CRT), which are commonly known in the prior art.

Cellulose acetate lends itself particularly well to providing frames of eyeglasses owing to the ease with which it can be worked, and also owing to the great variety of colors and patterns that it is possible to create. In fact, sheets of cellulose acetate can be produced in a practically infinite range of colorings: transparent, opaline or opaque, single-color, patterned (e.g. Havana) or variegated, with the possibility of creating aesthetic effects that are difficult to obtain with other materials.

Acetate sheets that are produced with such colors and patterns are then worked in order to obtain the desired shape of the frame, for example by means of milling, blanking or laser-cutting techniques. Then come the steps of finishing, polishing and/or surface treatments (e.g. laser) in order to obtain the end product.

The color gradation is one of the effects that can be attractive for frames of eyeglasses, for example, sunglasses and/or eyeglasses. The same is true for “goggle”-style eyeglasses frames, i.e. with a form of continuity between the two lenses, with no clear point of separation between them.

In the prior art, it is known to create color gradations on cellulose acetate with a coloring of the conventional type, i.e. a classic single color gradation with a gradient. However, with commonly-known techniques it is not possible to obtain a superimposed double-color gradation effect, or multiple color gradations, or multiple color gradations in non-coinciding directions.

### SUMMARY

The aim of the present disclosure is to provide a frame made of cellulose acetate that has at least two color gradations, arranged superimposed so as to create an extremely pleasing aesthetic effect.

Within this aim, the present disclosure provides a frame for eyeglasses wherein the color gradations can have practically infinite tonalities and directions of orientation.
the present disclosure also provides a frame for eyeglasses wherein the color gradation can render each frame a unique object, since the possible color gradations that can be produced are infinite
the present disclosure further provides a frame for eyeglasses that is highly reliable, easily and practically implemented, and at low cost.

This aim and these and other advantages which will become better apparent hereinafter are achieved by providing a frame for eyeglasses, characterized in that it comprises at least one first acetate sheet having a color gradation at least on part of the first acetate sheet and a transparency along at least one second part thereof, and at least one second acetate sheet having a color gradation on at least one part of the second acetate sheet, said first and second acetate sheets being coupled together by superimposition.

### BRIEF DESCRIPTION OF THE DRAWINGS

Further characteristics and advantages of the disclosure will become better apparent from the description of a preferred, but not exclusive, embodiment of the frame according to the present disclosure, which is illustrated by way of non-limiting example in the accompanying drawings wherein:

FIG. 1 is a side view of the sheet used to provide the frame according to the present disclosure;

FIG. 2 is a plan view of the sheet used to provide the frame according to the present disclosure;

FIG. 3 is a front view of the frame according to the disclosure, made of the sheet of FIGS. 1 and 2;

FIG. 4 is a plan view of the sheet used to provide the frame according to the present disclosure, according to a second embodiment;

FIG. 5 is a side view of the sheet used to provide the frame according to the present disclosure, according to the second embodiment; and

FIG. 6 is a front elevation view of the frame according to the present disclosure with a horizontal color gradation.

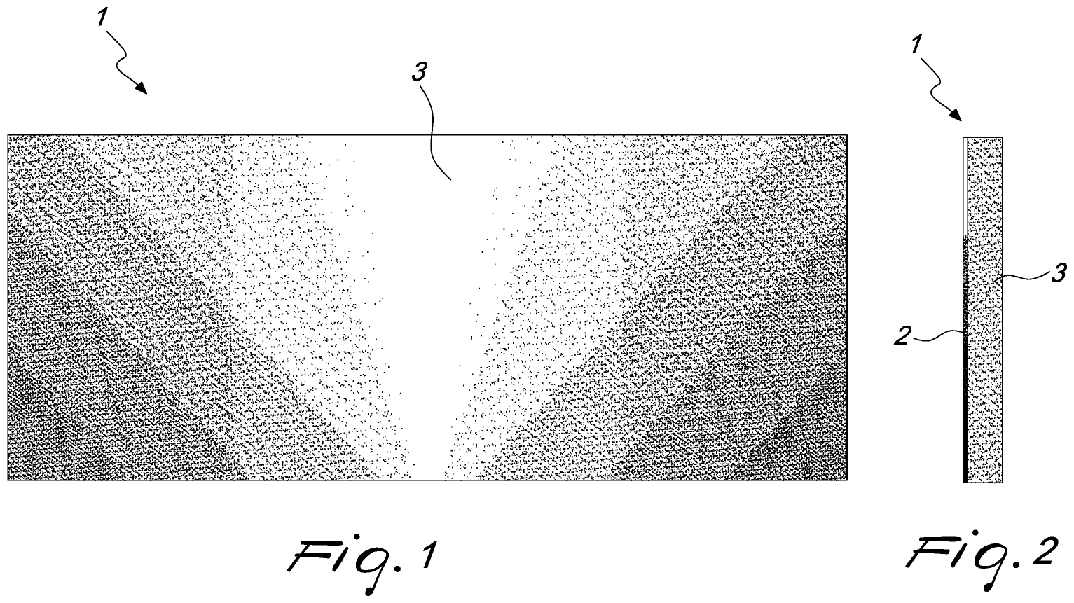

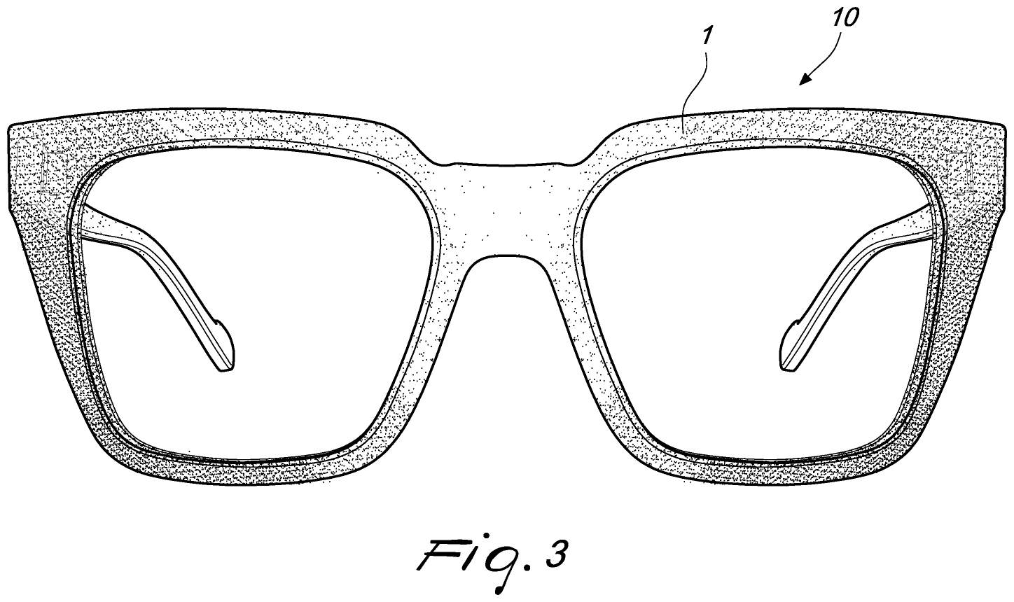

### DETAILED DESCRIPTION OF THE DRAWINGS

With reference to the figures, the frame for eyeglasses according to the present disclosure, generally indicated with the reference number 10, is made of a sheet 1 that comprises a first layer made with at least one first acetate sheet 2 which acts as the front or “top” of the frame and which is conveniently created so as to have a gradated color tonality along at least one first part of the sheet and a transparency along at least one second part, and at least one second acetate sheet 3, which acts as the base or rear part of the frame, also gradated, along at least a part of the sheet.

The two sheets 2 and 3 are adapted to be coupled together so as to produce color effects and color gradations, obtained by means of suitably superimposing the regions of color and of transparency. The end effect is that of a superimposed multiple color gradation that is particularly pleasing to look at. Specifically the superimposition occurs by means of adhesive bonding or other techniques that are commonly known in the prior art.

The disclosure therefore also relates to a method for providing a frame with color gradation, which is obtained by making at least one first acetate sheet 2 having a color gradation at least on part of the sheet and a transparency along at least one second part, making at least one second acetate sheet 3, also having a color gradation at least on part of the sheet, and finally coupling the two sheets 2 and 3 together, so as to obtain a manufactured article from which it is possible to cut out and shape the desired eyeglasses frame 10.

The coupling of the two sheets 2 and 3 occurs by means of adhesive bonding and specific orientation of the two sheets in order to create the plays of color and color gradations desired.

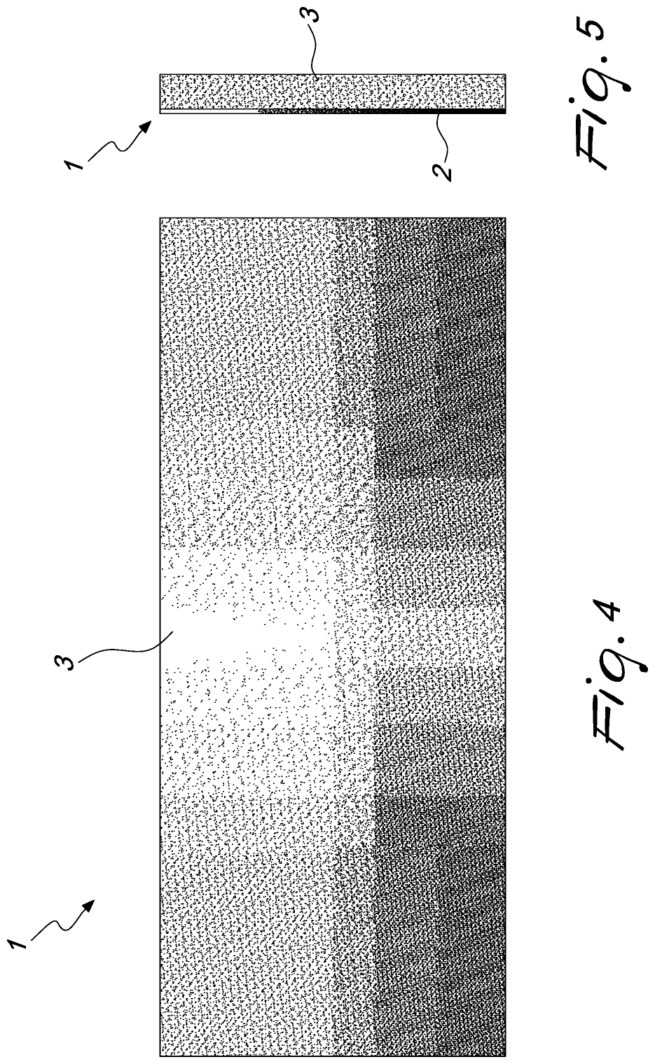

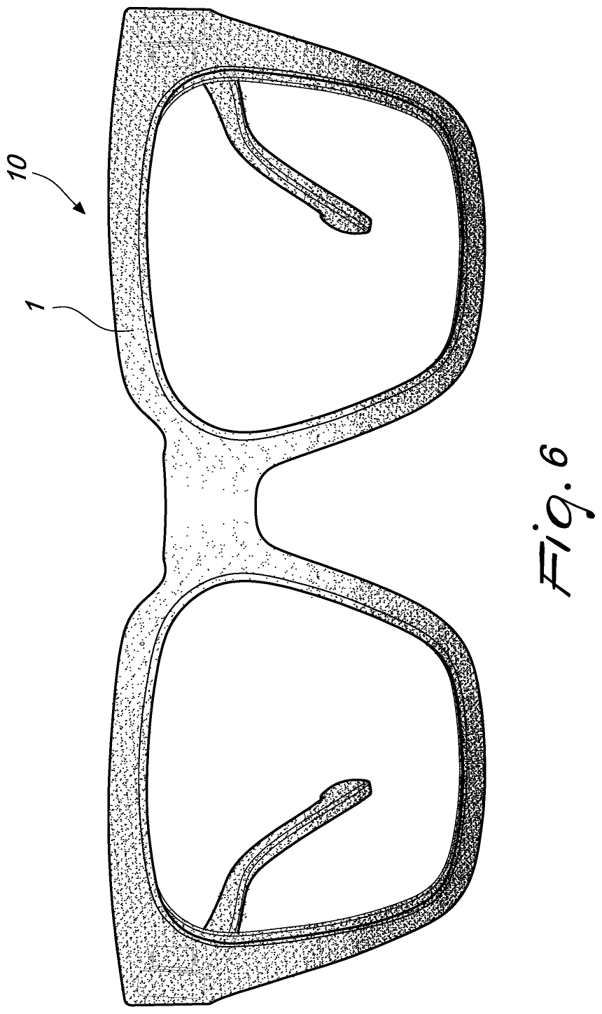

In a preferred embodiment, the first acetate sheet can be oriented only horizontally or vertically (90°) with respect to the second sheet. In this case the color gradation is “horizontal”, as illustrated in FIGS. 4-6.

In an alternative embodiment the second acetate sheet 3 can be oriented along any direction with respect to the first sheet 2. In this manner it is possible to have color gradations in any direction, even diagonal.

Finally, in an additional alternative embodiment, more sheets can be added to the first and second sheets, conveniently colored and/or arranged so as to create further superimpositions of color gradations.

In a further embodiment, the first sheet can be treated by means of a laser removal technique in order to create particularly pleasing aesthetic effects such as satin finishing or opacification of the surface and/or the etching of details such as logos and/or wordings.

The frame according to the disclosure can conveniently be made of bioacetate.

In practice it has been found that the frame for eyeglasses according to the present disclosure fully achieves the set aim and advantages, in that it makes it possible to obtain colorings that are always different, with practically infinite color gradations, starting from a pair of sheets of acetate or bioacetate superimposed on each other.

The frame and the method, thus conceived, are susceptible of numerous modifications and variations, all of which are within the scope of the appended claims.

Moreover, all the details may be substituted by other, technically equivalent elements.

In practice, the materials used, as well as the contingent shapes and dimensions, may be any according to the requirements and to the state of the art.

1. A frame for eyeglasses with color gradation, the frame comprising: at least one first acetate sheet having a color gradation on at least one part of the first acetate sheet and a transparency along at least one second part thereof, and at least one second acetate sheet having a color gradation on at least one part of the second acetate sheet, said first and second acetate sheets being coupled together by superimposition.

2. The frame according to claim 1, wherein said first acetate sheet is configured to be arranged on a front of the eyeglasses frame.

3. The frame according to claim 1, wherein said second acetate sheet is configured to be arranged on a rear part of the eyeglasses frame.

4. The frame according to claim 1, wherein other sheets having different color gradations are superimposed on said at least one first and second acetate sheets configured to obtain multiple color gradations.

5. The frame according to claim 1, wherein said second acetate sheet comprises a color gradation at least on one part of the second acetate sheet and a transparency along at least one second part thereof.

6. The frame according to claim 1, wherein said first and second acetate sheets are coupled by adhesive bonding.

7. The frame according to claim 1, wherein the acetate of the first and second acetate sheets is a bioacetate.

8. The frame according to claim 1, wherein said eyeglasses are goggles.

9. A method for manufacturing a frame for eyeglasses, the method including the following steps:
providing a first acetate sheet with color gradation coloring at least in part of the first acetate sheet and transparent in another part thereof;
providing a second acetate sheet with color gradation coloring at least in part of the second acetate sheet;
coupling said first acetate sheet and second acetate sheet by superimposing and orienting the two sheets; and
cutting, within said first and second coupled acetate sheets, an outline of a desired frame for eyeglasses.

10. The method according to claim 9, wherein the first acetate sheet is oriented horizontally or vertically with respect to said second acetate sheet.

11. The method according to claim 9, wherein the second acetate sheet is oriented in any direction with respect to said first acetate sheet.

12. The method according to claim 9, wherein said first and second acetate sheets are coupled by adhesive bonding.

13. The method according to claim 9, wherein said first acetate sheet is treated by laser removal to create additional aesthetic effects.

14. The method according to claim 9, wherein that other sheets having different color gradations are superimposed on said first and second acetate sheets in order to obtain multiple color gradations.
